(19) United States
(12) Patent Application Publication
(10) Pub. No.: US 2014/0030507 A1
(43) Pub. Date: Jan. 30, 2014

(54) FLUORESCENT FILM AND DISPLAY FILM

(71) Applicant: PANASONIC CORPORATION, Osaka (JP)

(72) Inventors: Shinji YOSHIDA, Shiga (JP); Tsuyoshi TANAKA, Osaka (JP); Takuma KATAYAMA, Kyoto (JP); Kazuhiko YAMANAKA, Osaka (JP)

(73) Assignee: PANASONIC CORPORATION, Osaka (JP)

(21) Appl. No.: 14/038,620

(22) Filed: Sep. 26, 2013

Related U.S. Application Data
(63) Continuation of application No. PCT/JP2012/001496, filed on Mar. 5, 2012.

(30) Foreign Application Priority Data
Mar. 31, 2011 (JP) 2011-080738

(51) Int. Cl. C09K 11/02

(52) U.S. Cl. CPC C09K 11/025
USPC 428/323; 252/301.36

(57) ABSTRACT

A fluorescent film according to the present invention includes a transparent resin layer which dispersively holds semiconductor nanocrystals. The semiconductor nanocrystals are quantum dot phosphors having fluorescence excitation spectra that differ depending on particle size of the quantum dot phosphors. The transparent resin layer is either water soluble or water dispersible. This makes it possible to uniformly disperse the semiconductor nanocrystals in a highly dense and highly uniform state, which contributes to implementing a thin fluorescent film having high reliability, high efficiency, and high color rendering properties.

### CROSS REFERENCE TO RELATED APPLICATIONS

This is a continuation application of PCT International Application No. PCT/JP2012/001496 filed on Mar. 5, 2012 designating the United States of America, which is based on and claims priority of Japanese Patent Application No. 2011-080738 filed on Mar. 31, 2011. The entire disclosures of the above-identified applications, including the specifications, drawings and claims are incorporated herein by reference in their entirety.

### FIELD

The present invention relates to a fluorescent film and a display film to be used for display devices or lighting devices having light sources.

### BACKGROUND

Recent years have seen active development of display devices and lighting devices equipped with small and power-saving light-emitting-diode (LED) light sources. The development involves efforts to implement high-luminance white LEDs having higher efficiency and higher color rendering properties. A typical white LED is made of a combination of blue LED light sources and one of green phosphors and yellow phosphors. In order to achieve higher efficiency and higher color rendering properties, desirable phosphors need to have excellent light emitting properties and energy conversion efficiency. Typical phosphors for use in a white LED are crystal fine particles having rare earth ions as an activator, and are often chemically stable. The light absorption efficiency of these phosphors increases as concentration of rare earth becomes higher; however, excessively high concentration inevitably causes concentration quenching to decrease light emitting efficiency. Thus, it is difficult for the typical phosphors to achieve high quantum efficiency of at least 80%.

To overcome the difficulty, many types of semiconductor phosphor fine particles have been proposed to achieve high quantum efficiency through direct utilization of light absorption and light absorption and emission at a band edge. In particular, fine particles having a particle size of several nanometers to several dozen namomenters; namely quantum dot phosphors, are expected to be introduced as new phosphors materials which do not include rare earth. Thanks to the quantum size effect that controls particle sizes even though the particles are made of the same material, a quantum dot phosphor can obtain a fluorescence spectrum of a desired wavelength range in the visible light region. Moreover, the quantum dot phosphors absorb light and become fluorescent at the band edges. Hence, the external quantum efficiency of the quantum dot phosphors is almost as high as 90%. Thus, the quantum dot phosphors are expected to be applied in white LEDs with higher high efficiency and high color rendering properties.

A quantum dot phosphor is, however, small in particle size, and the proportion of its surface area to its dimension is large. Thus, quantum dot phosphors are often chemically unstable. In particular, quantum dots of III-V and II-VI semiconductor compounds have a serious problem of causing a sudden decrease in light emitting efficiency when used in oxygen and water.

Hence, one of disclosed techniques is to apply inorganic coatings to phosphor fine particles to achieve high reliability (see Patent Literature 1). Specifically, in the disclosed technique as shown in FIG. 12, one or more phosphor fine particles 2 are coated (protected) with inorganic thin films 3, such as oxide-resistant and moisture-resistant aluminum and silicon dioxide film, to form a capsule 1. Such a technique makes it possible to reduce deterioration of the phosphor fine particles 2 caused by photo-oxygenation reactions due to operation of the phosphor fine particle for a long period of time.

### CITATION LIST

### Patent Literature

[PTL 1] Japanese Unexamined Patent Application Publication No. 2002-188084

### SUMMARY

### Technical Problem

The technique, however, faces a difficulty in controlling the number of phosphor fine particles 2 included in the capsule 1 and the size of the capsule 1. Consequently, the particle size of the capsule 1 including the phosphor fine particles 2 varies between several microns to several hundred microns. Hence, when the phosphors are included in silicone resin, the phosphors are deposited in the lower part of the silicone resin due to a sedimentation phenomenon. This causes a problem that the phosphors disperse non uniformly. Consequently, the non-uniform dispersal develops an non-uniform concentration of the phosphors, which causes non-uniform light emission.

There is another known technique to directly mix the quantum dot phosphors with epoxy resin and acrylic resin having high oxide resistivity and moisture resistivity, instead of including the quantum dot phosphors in a capsule, and form fluorescent film by thermally hardening the quantum dot phosphors. The known technique, however, merely involves mixing quantum dot phosphors with epoxy resin and acrylic resin. Hence, the technique has a problem of not only insufficient disperse of the quantum dot phosphors but also a difficulty in depositing an uniformly-thick film.

The present invention is conceived in view of the above problems and aims to an object to provide a fluorescent film which has high efficiency and high color rendering properties and achieves both high reliability and high uniformity, and a display film including the fluorescent film.

### Solution to Problem

According to an aspect of the present invention, a fluorescent film includes: semiconductor nanocrystals; and a transparent resin layer made of transparent resin that dispersively holds the semiconductor nanocrystals, wherein the semiconductor nanocrystals are quantum dot phosphors having fluorescence excitation spectra that differ depending on particle size of the quantum dot phosphors, and the transparent resin is either water soluble or water dispersible.

Here, each of the semiconductor nanocrystals may be formed of at least three layers, and an outer-most layer of the each semiconductor nanocrystal may be hydrophobic.

Since the above features allow the semiconductor nanocrystals to be easily caught by a main chain framework of water-soluble resin with hydrophobic interaction, the semiconductor nanocrystals are dispersively held in a highly dense and highly uniform state. These characteristics implement a fluorescent film which provides uniform light emission having high efficiency and high color rendering properties.

Here, the transparent resin may be one of acrylic based, fluorine based, and epoxy based.

The above feature shows that when one of fluorine-based resin and epoxy-based resin, both having excellent oxide resistivity and moisture resistivity, is used to dispersively hold semiconductor nanocrystals, photo-oxygenation reactions of the semiconductor nanocrystals are reduced. These characteristics implement a fluorescent film which provides uniform light emission having high efficiency and high color rendering properties. In addition, the use of acrylic resin having high transparency successfully implements a fluorescent film having high luminance and high efficiency.

The transparent resin may be deposited on a transparent conductive film.

The feature shows that resin including semiconductor nanocrystals is deposited on a flexible substrate, such as one made of conductive transparent resin. Such characteristics implement a fluorescent film which can receive excitation light on both surfaces, can be folded, and has high tensile strength.

Here, at least one surface of the transparent resin may be coated with a transparent inorganic compound having oxygen barrier properties.

The feature makes it possible to reduce photo-oxygenation reactions of the semiconductor nanocrystals under an operation for a long period of time. Such characteristics successfully implement a fluorescent film having high efficiency, high color rendering properties, and high reliability.

Here, the transparent resin may be deposited on a thin metal film.

The feature shows that total fluorescence from phosphors dispersed in resin can be reflected off a metal surface. Such characteristics successfully implement a fluorescent film having high luminance.

As another structure, the fluorescent film according to an implementation of the present invention may include: semiconductor nanocrystals having fluorescence excitation spectra that differ depending on particle size of the semiconductor nanocrystals; and a transparent resin layer which dispersively holds the semiconductor nanocrystals, wherein the transparent resin layer may be either water soluble or water dispersible, and made of a mixed solution including the semiconductor nanocrystals and transparent resin.

The features show that since resin layer is deposited after quantum dot phosphors are dispersed into water-soluble resin in solution, the semiconductor nanocrystals can be dispersively held in the resin layer in a highly dense and highly uniform state. Such characteristics successfully implement a fluorescent film which provides uniform light emission with high efficiency and high color rendering properties.

The transparent resin layer may be electro-deposited on a conductive substrate.

The feature allows ion resin to cause semiconductor nanocrystals, which are dispersed in solution, to move to the substrate, and the semiconductor nanocrystals can be dispersively held in a resin layer in a highly dense and uniform state. Such characteristics successfully implement a fluorescent film which provides uniform light emission with high efficiency and high color rendering properties.

As another structure, the fluorescent film according to an implementation of the present invention may include: a transparent resin layer which does not include the semiconductor nanocrystals; and at least one fluorescent resin layer which dispersively holds the semiconductor nanocrystals, wherein the transparent resin layer may be provided with the at least one fluorescent resin layer, and the transparent resin layer may coat one or both surfaces of the at least one fluorescent resin layer.

The features allow a phosphor layer to be two-dimensionally provided in an intended form so that a region in the intended form can glow. Such characteristics successfully implement a fluorescent film having high efficiency.

### Advantageous Effects

The present invention successfully implements a fluorescent film which has high efficiency and high color rendering properties and achieves both high reliability and high uniformity, and a display film including the fluorescent film.

More specifically, the fluorescent film including semiconductor nanocrystals and transparent resin according to an implementation of the present invention is deposited in the following process: semiconductor nanocrystals (quantum dot phosphors) are dispersed in water-soluble resin solvent which has excellent oxygen barrier properties and moisture resistivity to deposit a resin layer; and then, a substrate is removed. This makes it possible to uniformly disperse the semiconductor nanocrystals in a highly dense and highly uniform state, which contributes to implementing a thin fluorescent film having high reliability, high efficiency, and high color rendering properties.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1A depicts a schematic view of a fluorescent film according to an implementation of the present invention.

FIG. 1B depicts a schematic view of the fluorescent film according to an implementation of the present invention.

FIG. 2 depicts a schematic view showing how epoxy resin according to an implementation of the present invention becomes water soluble.

FIG. 3 schematically shows how quantum dot phosphors according to an implementation of the present invention are caught with resin.

FIG. 4 schematically shows a cross-sectional view of a quantum dot phosphor according to an implementation of the present invention.

FIG. 5 schematically shows a cross-sectional view of a fluorescent film according to an implementation of the present invention.

FIG. 6 schematically shows electrodeposition according to an implementation of the present invention.

FIG. 7A depicts a cross-sectional view showing a process of depositing a fluorescent film according to an implementation of the present invention.

FIG. 7B depicts a cross-sectional view showing a process of depositing the fluorescent film according to an implementation of the present invention.

FIG. 7C depicts a cross-sectional view showing a process of depositing the fluorescent film according to an implementation of the present invention.

FIG. 7D depicts a cross-sectional view showing a process of depositing the fluorescent film according to an implementation of the present invention.

FIG. 7E depicts a cross-sectional view showing a process of depositing the fluorescent film according to an implementation of the present invention.

FIG. 8 schematically shows a cross-sectional view of a fluorescent film according to the present invention.

FIG. 9 schematically shows a cross-sectional view of a fluorescent film according to an implementation of the present invention.

FIG. 10 schematically shows a cross-sectional view of a fluorescent film according to the present invention.

FIG. 11A depicts a cross-sectional view showing a process of depositing a fluorescent film according to an implementation of the present invention.

FIG. 11B depicts a cross-sectional view showing a process of depositing the fluorescent film according to an implementation of the present invention.

FIG. 11C depicts a cross-sectional view showing a process of depositing the fluorescent film according to an implementation of the present invention.

FIG. 11D depicts a cross-sectional view showing a process of depositing the fluorescent film according to an implementation of the present invention.

FIG. 11E depicts a cross-sectional view showing a process of depositing the fluorescent film according to an implementation of the present invention.

FIG. 12 depicts a cross-sectional view showing a conventional phosphor.

### DESCRIPTION OF EMBODIMENTS

### Embodiment 1

Described hereinafter is a fluorescent film according to Embodiment 1 of the present invention, with reference to the drawings.

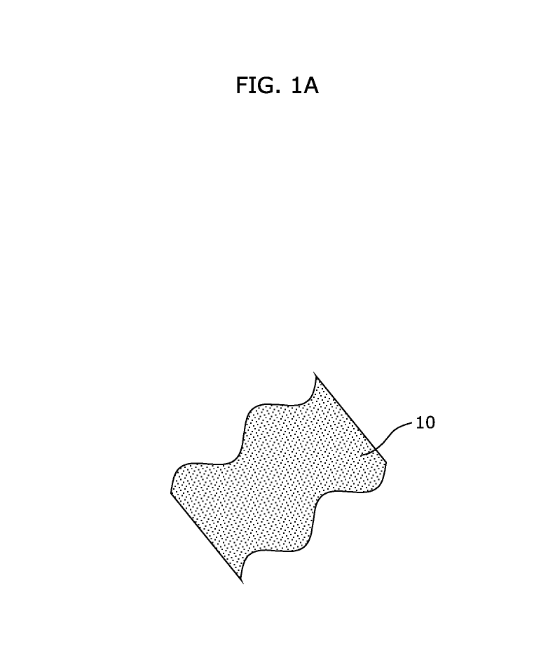

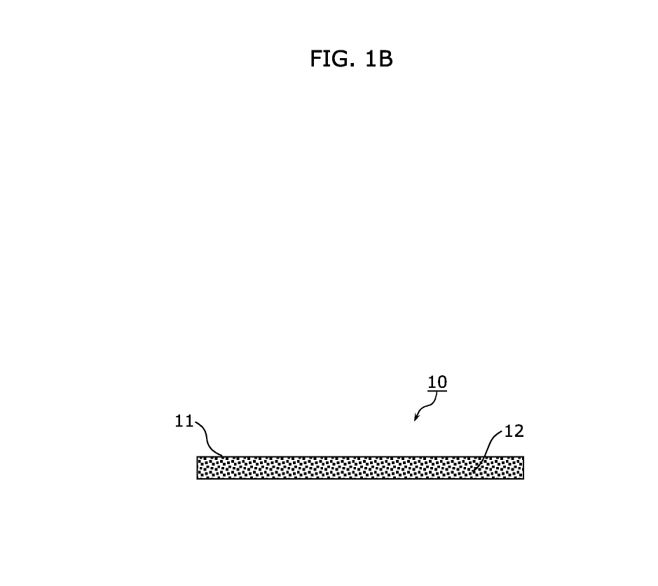

FIGS. 1A and 1B are schematic views of the fluorescent film according to the present invention. Specifically, FIGS. 1A and 1B schematically show film including quantum dot phosphors (hereinafter referred to as fluorescent film) and achieving both high reliability and high dispersibility. A fluorescent film 10 is made of transparent resin having oxygen barrier properties and moisture resistivity. In particular, the transparent resin in Embodiment 1 is epoxy-based one. The epoxy-based resin is two to three digits lower in oxygen permeability than the silicone resin. Once aminized, the epoxy-based resin is one of resins which easily become water soluble and water dispersible. Other than the epoxy-based resin, the fluorine-based resin has high oxygen barrier properties and moisture resistivity and is capable of reducing photo-oxygenation reactions of the quantum dot phosphors.

The fluorescent film 10 is single-layer film of 30 μm or thinner in thickness. With its excellent flexibility, the fluorescent film 10 can be folded. As exemplified in FIG. 1B, the fluorescent film 10 is deposited of a resin layer 11 including uniformly-dispersed quantum dot phosphors 12; namely, semiconductor nanocrystals.

As described above, the fluorescent film according to an implementation of the present invention is formed of resin having oxygen barrier properties and moisture resistivity. Such a feature allows the fluorescent film to reduce its deterioration such as photo-oxygenation of phosphors.

Described next is the details of the fluorescent film in line with a manufacturing process thereof. In depositing the fluorescent film according to an implementation of the present invention, mainly required are three processes: dispersing phosphor fine particles, depositing a resin layer, and shaping the resin layer into film. Hereinafter, each process shall be detailed.

The resin layer 11 is characterized to be formed of water-soluble or water-dispersible resin solvent. In water solution, part of the molecular framework of water-soluble resin is ionized or has electrical polarity. Since the polarized portions and the ionized regions of the resin molecules are stabilized by hydration, the water-soluble resin dissolves or disperses in water to become an emulsion.

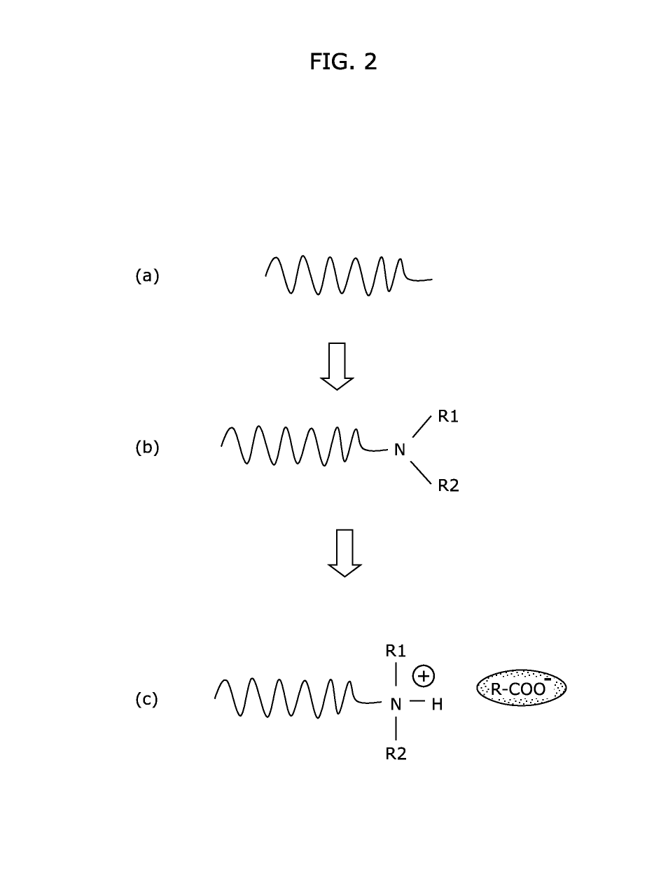

FIG. 2 shows how the epoxy resin according to Embodiment 1 of the present invention becomes water soluble. As shown in the illustrations (a) to (c) in FIG. 2, an end of the epoxy resin is aminized and neutralized by acid, and the epoxy resin is ionized. It is noted that, in an implementation of the present invention, acetic acid is used for the ionization as an example.

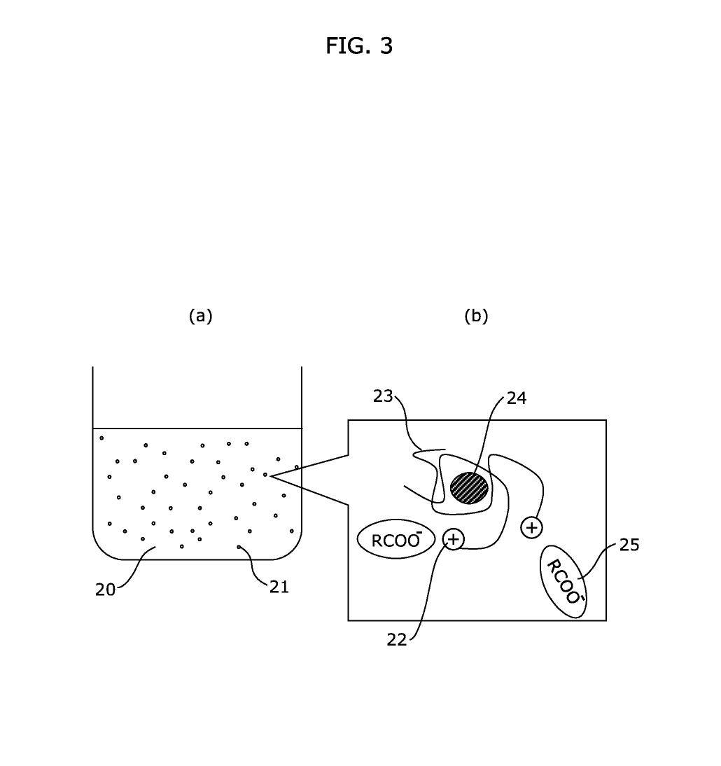

FIG. 3 schematically shows how quantum dot phosphors are caught with resin. The illustrations (a) and (b) in FIG. 3 show that when semiconductor nanocrystals 21 are added to resin solution 20 which is neutralized by acid ions 25, main chains 23 catch quantum dot phosphors 24; namely, the semiconductor nanocrystals 21. Here, the main chains 23 have aminized cation sites 22, and are formed of epoxy resin solvent molecules. Hence, the semiconductor nanocrystals 21 uniformly disperse in the resin solution 20. Here, excessively large semiconductor nanocrystals 21 cannot be caught by the main chains of the resin. Thus, such semiconductor nanocrystals 21 settle out and are deposited. Commercially available rare earth phosphors and the capsule phosphors that disclosed in Patent Literature 1, for example, have particle sizes of fpm to 100 μm. In other words, such phosphors are far larger than the resin molecules. Thus, in order to catch a rare earth phosphor fine particle, many resin molecules are required. This consequently leads to a decrease in dispersed concentration of the phosphors and settle-out of the phosphors in the water-soluble resin, which causes non-uniform luminance and light emission.

In contrast, the quantum dot phosphors 24 are 1 nm to 20 nm in particle size, and as small as or smaller than water-soluble resin molecules. Hence, the quantum dot phosphors 24 can uniformly disperse in resin solution in high concentration. The semiconductor nanocrystals 21 according to Embodiment 1 are quantum dot phosphors 24 of 1 nm and 10 nm in particle size whose cores are InP. Materials for the phosphors may be water insoluble. Other than InP, known materials such as cadmium-based quantum dot phosphors and chalcogenide-based fine particles may be used.

Here, most of the quantum dot phosphors are double layered or triple layered, which is also referred to as core shelled, in order to improve light emitting efficiency and reliability. For efficient dispersal of the quantum dot phosphors in water-soluble resin solvent, the chemical characteristics of the outer-most layers of the quantum dots are important. As shown in the illustration (b) in FIG. 3, the water-soluble resin and the water-dispersible resin have the ends of the resin frameworks either ionized or polar functionalized. In contrast, the molecular frameworks thereof are formed of hydrocarbon such as alkyl main chains and have very little polarity. This means that the water-soluble resin and the water-dispersible resin do not interact very much with water, and act as hydrophobic radical. In order for the quantum dot phosphors to be caught by the main chains of the water-soluble resin, the outer-most layers of the phosphor fine particles have to be formed of ligands and layers which have no polarity or low polarity. Such a feature allows the quantum dot phosphors to be caught by the resin main chains with hydrophobic interaction.

### Embodiment 2

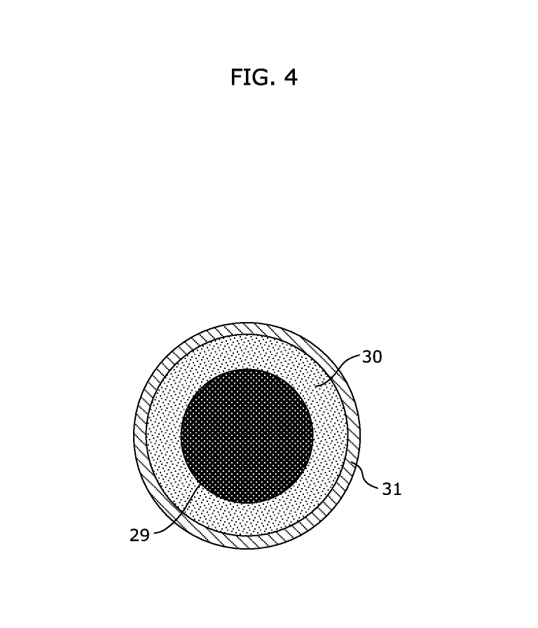

Described is Embodiment 2 of the present invention, with reference to FIG. 4.

FIG. 4 schematically shows a cross-sectional view of a quantum dot phosphor according to an implementation of the present invention. The quantum dot phosphor in Embodiment 2 is triple layered. Here, a core 29 is made of InP. The core 29 is coated with a shell layer 30 made of ZnS. The outer-most layer is a ligand layer 31. The ligand layer 31 is made of octane-based hydrocarbon acting as a ligand and bonding with the shell layer 30. Since the ligand layer 31 is made of highly hydrophobic hydrocarbon and functions as the outer-most layer, the quantum dot phosphor is efficiently caught by main chains of resin molecules in water solution. As a result, quantum dots can dissolve very uniformly in high concentration in the water solution to become an emulsion.

The core particle size of a quantum dot phosphor is small, which is approximately between 10 nm and 100 nm even though the quantum dot phosphor is a multi-layered particle including a core, a shell, and a ligand. Hence, sizes of the quantum dot phosphors do not affect dispersion thereof in resin solution. It is noted that the shell layer 30 and the ligand layer 31 shall not be limited as far as their materials are water insoluble.

The ligand layer 31 preferably has a close hydrophobic interaction with resin solvent. Hence, the molecules thereof may have alkyl main chains. Here, it is preferable for the ligand layer 31 to have fewer molecules to achieve higher dispersibility from resin solvent. Specifically, since the resin solvent has to stay liquid at room temperature, the carbon number of the ligand layer 31 needs to be equal to 15 or smaller.

In addition, as described above, one of the features of the quantum dot phosphors is that the fluorescence wavelengths thereof differ depending on their particle sizes. Hence, in order to manufacture a fluorescent film which glows fluorescent white, a resin layer may be formed to include quantum dots whose particle sizes provide fluorescent red and other quantum dots whose particle sizes provide fluorescent green.

The particle sizes of the InP-based quantum dot phosphors according to Embodiment 2 are approximately between 5 nm and 8 nm for green phosphors. Red phosphors are largest in particle size of approximately between 10 nm and 20 nm.

Hence, in view of particle size, any quantum dot phosphors which emit fluorescent light to the visible light region—including red phosphors green phosphors and blue phosphors smaller than the green phosphors—can be dispersed in resin solution. Hence, when quantum dot phosphors having different particle sizes (different fluorescent wavelengths) are mixed with resin solution, a desired luminescent color may be obtained.

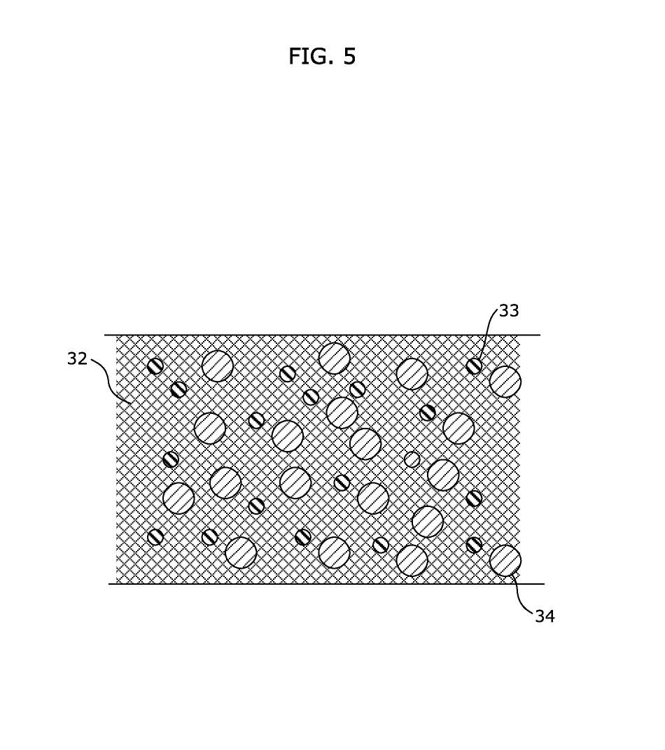

FIG. 5 schematically shows a cross-sectional view of white a fluorescent film. The white fluorescent film is assumed to be photoexcited by a blue LED. In resin film 32, green quantum dot phosphors 33 in small particle size and red quantum dot phosphors 34 are coexisted and dispersed.

Described next is how to form a resin layer from resin solution including the dispersed quantum dot phosphors. There are multiple techniques to apply water-soluble resin, such as atomization and electrodeposition.

The atomization is a technique to spray, to an object, resin solvent which has caught fine particles in the form of a liquid mist. The technique is capable of depositing a resin coating on any object as far as the object is excellent in wettability. It is difficult, however, to spray to form a uniformly-thick coating, and the resin coating would be uneven in thickness. Moreover, when the object is in a complex shape, the resin solvent might not be applied uniformly on some recesses on the object.

In contrast, the electrodeposition is a technique to apply a voltage to an object dipped into resin solution, and, by electrophoresis and electrochemical reactions, coating the surface of the object with ion resin solvent which has caught quantum dot phosphors. With the electrodeposition a coating is deposited by electrochemical reactions, which makes it possible to form a uniformly-thick resin layer. Hence, a uniformly-thick coating is deposited on the surface of the object even though the surface has a complex shape. The technique, however, utilizes electrochemical reactions, and cannot be used to form such a resin layer in the case where the object is not electrically conductive.

The fluorescent resin layer according to an implementation of the present invention is deposited by cation electrodeposition. FIG. 6 schematically shows the electrodeposition. As shown in FIG. 6, an object 28 and an anode electrode 26 are dipped into the epoxy-based resin solution 20 in which the semiconductor nanocrystals 21; namely quantum dot phosphors, are dispersed. The epoxy-based resin is aminized (cationized). Here, the object 28 works as a cathode, and an electrodeposited film 27 is deposited on the object. In contrast, when the resin solvent of the resin solution 20 is acid based, the object 28 works as an anode. Thus, the electrodeposited film 27 is deposited by anion electrodeposition. The resin coating deposited by the above techniques undergoes a drying process and a hardening process to be finalized.

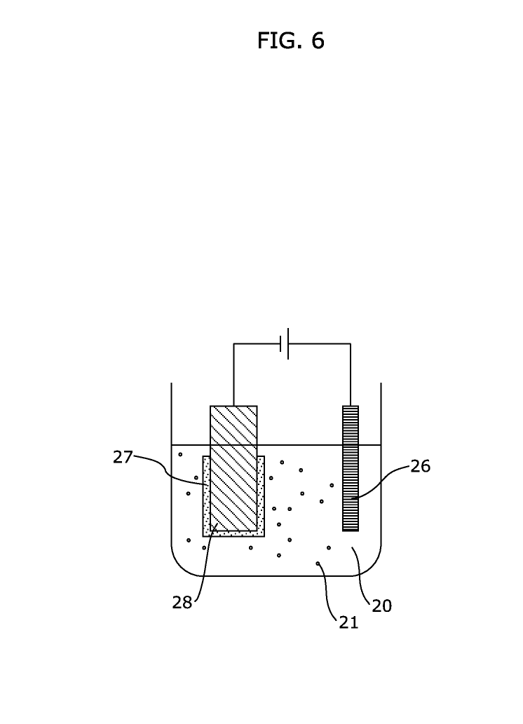

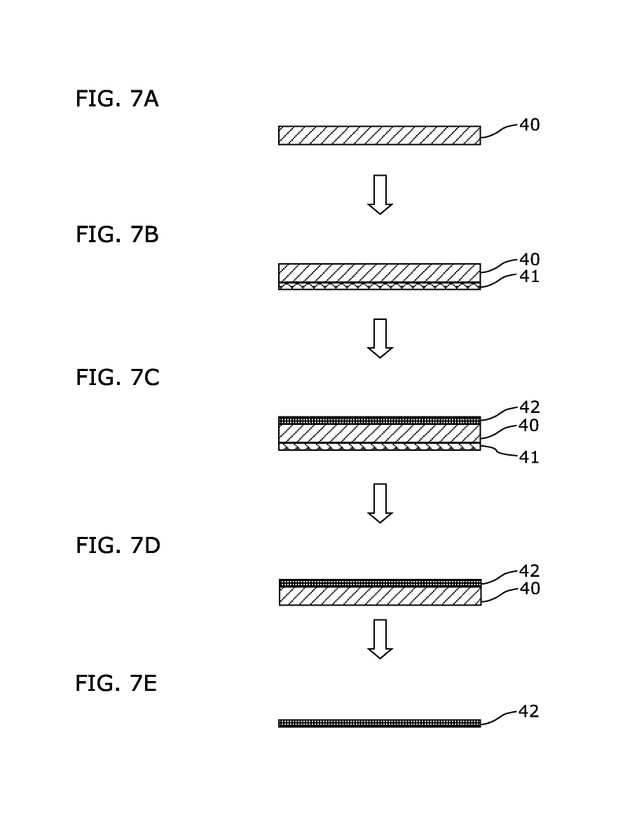

Described next is a process of depositing film, with reference to FIGS. 7A to 7E. FIGS. 7A to 7E illustrate how to delaminate, from a foundation substrate, an epoxy resin layer which dispersively holds quantum dot phosphors with electrodeposition. In Embodiment 2, aluminum foil 40 is used as an electrodeposited object. After one side of the aluminum foil 40 is protected with a resist 41 (FIG. 7B), a phosphor layer 42 is electrodeposited on the surface of the aluminum foil 40. Hence, a resin layer is deposited on only one side of the aluminum foil 40 (FIG. 7C). Here, the other side of the aluminum foil 40 may simply be kept from electric current. Instead of the resist 41, insulating film may simply be attached to the aluminum foil 40. After that, the aluminum foil 40 is removed with hydrochloric acid, and the fluorescent film is obtained.

It is noted that the electrodeposited epoxy resin layer is significantly tolerant of acid and alkali. In the case where the foundation is insoluble with hydrochloric acid, such as copper, sulfuric acid and nitric acid may be used to remove the aluminum foil 40. Instead of the epoxy resin, the after-described acrylic resin and fluorine-based resin may be used to obtain a fluorescent film through a similar process.

The obtained fluorescent film is 10 μm to 30 μm in thickness. Compared with silicone resin, epoxy resin is lower in oxygen permeability due to its higher oxygen barrier properties, and higher in moisture resistivity. Hence, when quantum dot phosphors are dispersed and held in epoxy resin with electrodeposition, reactions between the epoxy resin and oxygen/water can be reduced. Consequently, such a feature can provide a fluorescent film having high reliability, high efficiency, and high color rendering properties.

### Embodiment 3

Embodiment 3 exemplifies a case where fluorine-based resin is used. This is because when epoxy-based resin is left in high temperatures for a long period of time, the resin molecules of the epoxy-based resin continue to decompose and polymerize. Consequently, the epoxy-based resin becomes yellowish and deteriorates. Moreover, the decrease in transparency not only decreases light emitting efficiency of phosphors but also causes colors to be poorly balanced. In Embodiment 3, a fluorine-based electrodeposited polymeric film is used since the fluorine-based resin is free from the decrease in transparency that comes with deterioration.

Fluorine-based resin collectively includes resins in which olefin including fluorine is polymerized. Including polytetrafluoroethylene (PTFE), the fluorine-based resin according to Embodiment 3 is chemically stable and excellent in heat resistance, moisture resistivity, and oxidation resistance.

Such a feature makes it possible to produce a highly reliable fluorescent film without sacrificing transparency.

### Embodiment 4

Embodiment 4 according to the present invention exemplifies a case where acrylic resin is used as an electrodeposited resin layer.

Among electrodeposited resins, acrylic resin has the highest transparency and is excellent in weatherability, oxide resistivity, and moisture resistivity. Similar to epoxy resin solvent, acrylic resin solvent becomes easily water soluble when the ends of its molecules are aminized or carboxylated. Hence, the acrylic resin is suitable to dispersively hold quantum dot phosphors. The acrylic resin starts to soften at approximately 90 degrees Celsius, and is not useful under high temperatures. The acrylic resin, however, can dispersively hold quantum dot phosphors in a chemically stable condition, which makes it possible to provide a fluorescent film having high reliability and high color rendering properties.

### Embodiment 5

Embodiments 1, 3, and 4 describe how to deposit a single-layer fluorescent film. The single-layer fluorescent film deposited with electrodeposition is 10 μm to 30 μm in thickness, and thin as well as flexible. The downside is, however, that the single-layer fluorescent film is excessively thin and easily tears. Embodiment 5 exemplifies how to improve the fluorescent film in tensile strength.

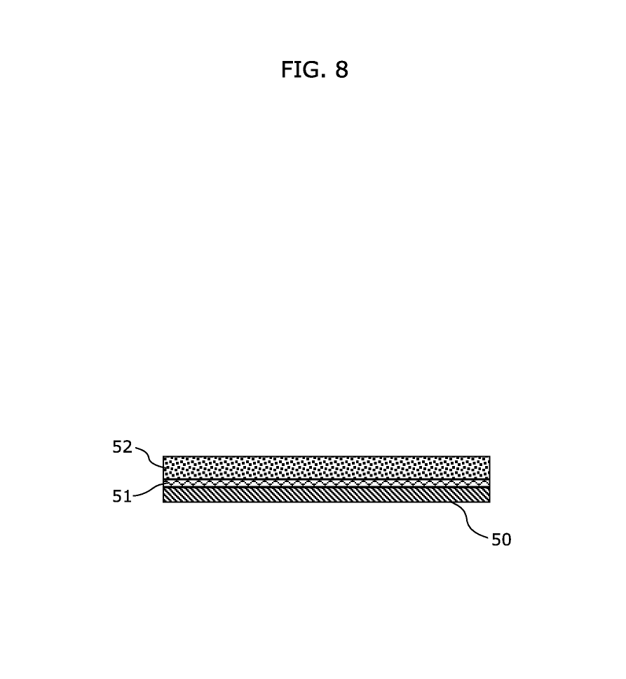

FIG. 8 schematically shows a cross-sectional view of a fluorescent film according to the present invention. Specifically, conductive polymer 51 is laminated on a transparent plastic sheet 50. Deposited on the conductive polymer 51, which works as an electrode, is a resin layer 52 including quantum dot phosphors. It is essential for the transparent plastic sheet 50 to have heat resistance since the transparent plastic sheet 50 is subject to a temperature of as high as 180 degrees Celsius in the drying and hardening processes in an electrodeposition process. In Embodiment 5, the transparent plastic sheet 50 is a transparent polyimide sheet. The transparent polyimide has high light transmission and heat resistance of as high as 300 degrees Celsius, and does not deteriorate in the electrodeposition process. On the transparent polyimide sheet, polythiophene-based conductive polymer is laminated as the conductive polymer.

It is noted that, similar to the transparent plastic sheet 50, many kinds of transparent conductive polymer is commercially available. Thus, the conductive polymer does not have to be polythiophene based in particular as far as the conductive polymer is excellent in heat resistance. The conductive polymer film may have an electrical contact point, so that a resin layer which dispersively holds quantum dot phosphors may be formed by electrodeposition.

In Embodiment 5, the top-most layer is a fluorescent resin layer; however, transparent resin may additionally be provided above the fluorescent resin layer. Such a feature makes it possible to provide a fluorescent film which is excited and glows on both surfaces, eliminating the need for a substrate removing process. Furthermore, compared with a single-layer fluorescent film, the fluorescent film in Embodiment 5 has high tensile strength. Such a feature makes it possible to provide a fluorescent film having high reliability.

### Embodiment 6

Embodiments 1, 3, and 4 describe how to deposit a single-layer fluorescent film. The single-layer fluorescent film deposited with electrodeposition is 10 μm to 30 μm in thickness, and thin as well as flexible. The downside is, however, that the single-layer fluorescent film is excessively thin and easily tears. Embodiment 6 describes an example, which is different from the one in Embodiment 5, showing how to improve a fluorescent film in tensile strength.

The cross-sectional view of a fluorescent film according to 6 is the same as the one in FIG. 8. Specifically, conductive polymer 51 is laminated on a transparent plastic sheet 50. Deposited on the conductive polymer 51, which works as an electrode, is a resin layer 52 including quantum dot phosphors. It is essential for the transparent plastic sheet 50 to have heat resistance since the transparent plastic sheet 50 is subject to a temperature of as high as 180 degrees Celsius in the drying and hardening processes in an electrodeposition process.

In Embodiment 6, the transparent plastic sheet 50 is a transparent polyimide sheet. The transparent polyimide has high light transmission and heat resistance of as high as 300 degrees Celsius, and does not deteriorate in the electrodeposition process. On the transparent polyimide sheet, polythiophene-based conductive polymer is laminated as the conductive polymer.

It is noted that, similar to the transparent plastic sheet 50, many kinds of transparent conductive polymer is commercially available. Thus, the conductive polymer does not have to be polythiophene based in particular as far as the conductive polymer is excellent in heat resistance. The conductive polymer film may have an electrical contact point, so that a resin layer which dispersively holds quantum dot phosphors may be formed by electrodeposition.

In Embodiment 6, the top-most layer is a fluorescent resin layer; however, transparent resin may additionally be provided above the fluorescent resin layer. Such a feature makes it possible to provide a fluorescent film which is excited and glows on both surfaces, eliminating the need for a substrate removing process. Furthermore, compared with a single-layer fluorescent film, the fluorescent film in Embodiment 6 has high tensile strength. Such a feature makes it possible to provide a fluorescent film having high reliability.

### Embodiment 7

Epoxy resin and fluorine-based resin, both dispersively holding quantum dot phosphors, have high oxygen barrier properties and moisture resistivity. The epoxy resin and fluorine-based resin, however, is as thin as or thinner than 30 μm, and this inevitably causes an increase in water and oxygen permeability along with an increase in temperature. Hence, exemplified is a case where a transparent inorganic material is deposited on a fluorescent film in order to further improve oxide resistivity and moisture resistivity.

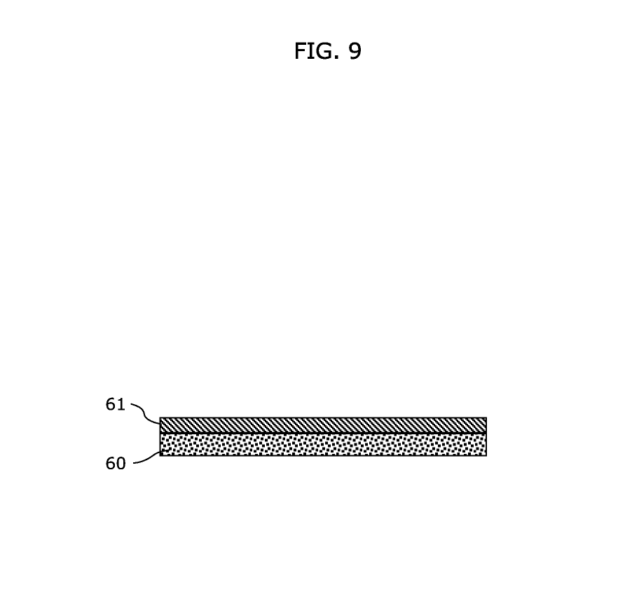

FIG. 9 schematically shows a cross-sectional view of a single-layer fluorescent film above which a transparent inorganic coating is provided. Specifically, an inorganic thin film 61 is deposited above a fluorescent film 60.

The inorganic thin film 61 according to Embodiment 7 is alumina (Al₂O₃). Sputtering is employed to deposit the inorganic thin film 61 above the fluorescent film 60. Resin alters by high-energy plasma and high temperature, and it is essential to use a technique to deposit the inorganic thin film 61 with low energy at a room temperature. Here, as less-damaging sputtering, used here is electron cyclotron resonance sputtering (ECR sputtering). A feature of the technique is that a plasma section and a deposition section are separated with each other, and a substrate is not directly exposed to high-energy plasma.

It is noted that the technique to deposit the inorganic thin film 61 shall not be limited in particular as far as the technique is a low-energy film-deposition one. Techniques usable at a room temperature, such as pulsed laser deposition and electron-beam evaporation, may be employed. Alumina has high oxygen barrier properties and moisture resistivity, and makes it possible to provide a fluorescent film having higher reliability. Any material other than alumina may be used as far as the material is transparent, such as nitride and oxynitride.

In addition, the inorganic thin film 61 may be deposited not only above a single-layer fluorescent film but also above the fluorescent resin layer provided above the conductive film and the fluorescent resin layer provided above a metal substrate according to Embodiments 4 and 6.

### Embodiment 8

In Embodiment 1, the fluorescent film is produced with removal of the aluminum foil. The resulting fluorescent film inevitably causes light to be emitted from both the surfaces of the film when excitation light enters only one of the surfaces. Consequently, the fluorescence intensity to be observed on a user's side is as little as for one side of the film, and a half of the intensity will be lost. A fluorescent resin layer is deposited on a conductive substrate having high reflectance, and light emitted from the resin layer is reflected off a surface of the substrate. Such a feature makes it possible to provide a fluorescent film having high luminance.

In Embodiment 8, gloss Ag is plated on a copper thin film. On the gloss Ag plating, an epoxy-based resin layer including quantum dot phosphors are electrodeposited. A metal film on which an electrodeposited layer is deposited may be any given metal film as far as the metal film has high reflectance and high gloss. An exemplary metal film is made of Ag, Al, Fe, Ni, and Pt. Moreover, the metal film does not have to be single layered; instead, the metal film provided on an insulated substrate may have a fluorescent resin layer electrodeposited thereon. For example, on insulating film having high heat resistance, such as polyimide film, an Ag layer is non-electrolytically plated and a phosphor layer is electrodeposited on the Ag. The process makes it possible to provide reflective a fluorescent film having high tensile strength. Such features allow the fluorescent film to glow with high luminance when excitation light is emitted to the phosphor layer by an LED or a semiconductor laser.

### Embodiment 9

Electrodeposition makes it possible to deposit a fluorescent resin layer only in a conductive region. Embodiment 9 exemplifies such an electrodeposition technique.

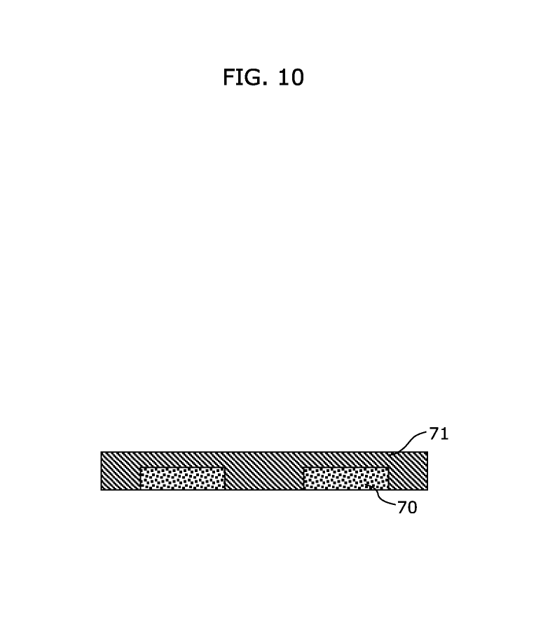

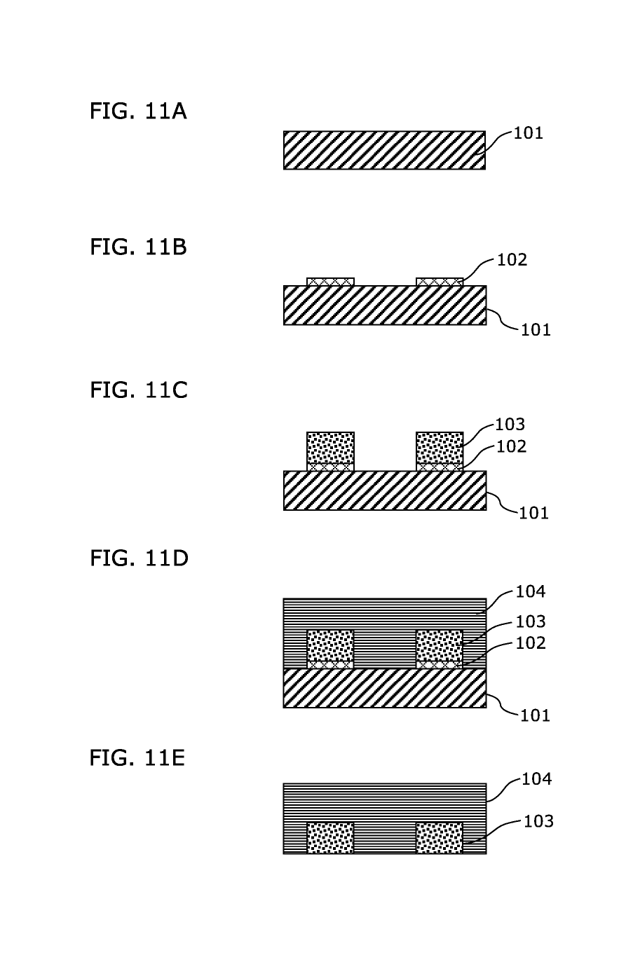

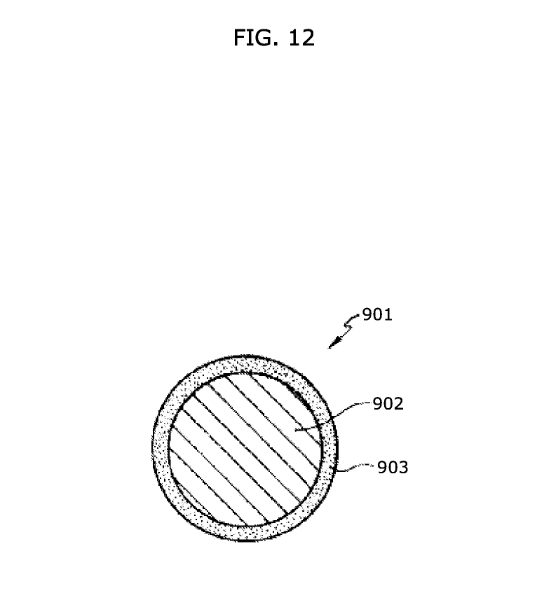

FIG. 10 schematically shows a cross-sectional view of a fluorescent film in a desired form. The fluorescent film can be formed in the following process: a fluorescent electrodeposition layer is deposited only in a conductive region, the fluorescent electrodeposition layer 70 is coated with silicone resin 71, and a substrate is removed. An exemplary patterning technique of how phosphor resin is patterned described with reference to FIGS. 11A to 11E.

FIGS. 11A to 11E depict cross-sectional views showing a process of depositing a fluorescent film according to an implementation of the present invention. A conductive film 102 is deposited on a substrate 101 which is, for example, transparent and insulative. With photolithography and etching or liftoff and, the conductive film 102 is patterned as intended. After that, electricity is applied to the conductive film 102 to form a fluorescent electrodeposition layer 103 only on the patterned portion of the conductive film 102 (FIG. 11C).

In Embodiment 7, sputtering is employed to deposit indium tin oxide (ITO: the conductive film 102), which is a transparent electrode, on a glass substrate (the substrate 101) which is double side polished. A resist is applied to the ITO (the conductive film 102), and an intended pattern is developed on the ITO with photolithography. The ITO is etched using the patterned resist as a mask, and the conductive region is successfully patterned.

It is noted that the state illustrated in FIG. 11C is sufficient; however, protective transparent silicone resin may be additionally applied over the ITO and the fluorescent electrodeposition layer 103 to cover the whole surfaces of the ITO and the fluorescent electrodeposition layer 103 (FIG. 11D). Such a process makes it possible to provide a fluorescent film having greater durability.

It is noted that, instead of a transparent insulated substrate, a metal substrate, such as an aluminum substrate, may be used for the substrate 101. On the metal substrate, only a region where no electrodeposition is provided is insulating-coated with a resist, and the metal substrate undergoes phosphor electrodeposition to form a fluorescent resin layer having an intended pattern. Here, the entire surface is coated with transparent silicone resin, and the metal substrate, which is a foundation, is removed by acid. Hence, the structure of the produced fluorescent resin layer looks like the illustration in FIG. 11E. Such a structure makes it possible to provide a fluorescent film and a display film having high durability and reliability.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

A fluorescent film and a display film according to an implementation of the present invention have high uniformity, high efficiency, and high color rendering properties. The fluorescent film and the display film are effective for use in a display device and a lighting device including a light source.

1. A fluorescent film comprising:
semiconductor nanocrystals; and
a transparent resin layer made of transparent resin that dispersively holds the semiconductor nanocrystals,
wherein the semiconductor nanocrystals are quantum dot phosphors having fluorescence excitation spectra that differ depending on particle size of the quantum dot phosphors, and
the transparent resin is either water soluble or water dispersible.

2. The fluorescent film according to claim 1,
wherein each of the semiconductor nanocrystals is formed of at least three layers, and an outer-most layer of the each semiconductor nanocrystal is hydrophobic.

3. The fluorescent film according to claim 1,
wherein the transparent resin is one of acrylic based, fluorine based, and epoxy based.

4. The fluorescent film according to claim 1,
wherein the transparent resin is deposited on a transparent conductive film.

5. The fluorescent film according to claim 1,
wherein at least one surface of the transparent resin is coated with a transparent inorganic compound having oxygen barrier properties.

6. The fluorescent film according to claim 1,
wherein the transparent resin is deposited on a thin metal film.

7. The fluorescent film according to claim 1, further comprising:
a transparent resin layer which does not include the semiconductor nanocrystals; and
at least one fluorescent resin layer which dispersively holds the semiconductor nanocrystals,
wherein the transparent resin layer is provided with the at least one fluorescent resin layer, and
the transparent resin layer coats one or both surfaces of the at least one fluorescent resin layer.

8. A display film which is formed of the fluorescent film according to claim 1.
